(19) United States
(12) Patent Application Publication
(10) Pub. No.: US 2023/0030348 A1
(43) Pub. Date: Feb. 2, 2023

(54) VEHICULAR EMERGENCY NOTIFICATION DEVICE

(71) Applicant: DENSO CORPORATION, Kariya-city (JP)

(72) Inventor: Mitsuru NAKAGAWA, Kariya-city (JP)

(21) Appl. No.: 17/968,034

(22) Filed: Oct. 18, 2022

Related U.S. Application Data
(63) Continuation of application No. PCT/JP2021/019467, filed on May 21, 2021.

(30) Foreign Application Priority Data
Jun. 2, 2020 (JP) 2020-096292

(51) Int. Cl. H04W 4/90; H04W 4/40; B60W 30/04; B60W 40/112; B60W 50/00

(52) U.S. Cl. CPC H04W 4/90; H04W 4/40; B60W 30/04; B60W 40/112; B60W 50/0097; B60W 2520/18; B60W 2556/45

(57) ABSTRACT

A vehicular emergency notification device mounted on a vehicle includes: a wireless communication unit wirelessly transmitting an emergency notification signal toward outside of the vehicle; and a rollover predicting unit acquiring a rollover-related quantity, which is a physical quantity for predicting a rollover of the vehicle, and predicting the rollover of the vehicle based on the acquired rollover-related quantity, wherein the wireless communication unit transmits the emergency notification signal in response to the rollover predicting unit predicting the rollover of the vehicle.

### CROSS REFERENCE TO RELATED APPLICATIONS

The present application is a continuation application of International Patent Application No. PCT/JP2021/019467 filed on May 21, 2021, which designated the U.S.

and claims the benefit of priority from Japanese Patent Application No. 2020-096292 filed on, Jun. 2, 2020. The entire disclosures of all of the above applications are incorporated herein by reference.

### TECHNICAL FIELD

The present disclosure relates to a vehicular emergency notification device.

### BACKGROUND

There has been known an emergency notification device that detects a collision accident and transmits an emergency notification signal to a center or the like outside the vehicle.

### SUMMARY

The present disclosure provides a vehicular emergency notification device mounted on a vehicle. The vehicular emergency notification device includes: a wireless communication unit wirelessly transmitting an emergency notification signal toward outside of the vehicle; and a rollover predicting unit acquiring a rollover-related quantity, which is a physical quantity for predicting a rollover of the vehicle, and predicting the rollover of the vehicle based on the acquired rollover-related quantity. The wireless communication unit transmits the emergency notification signal in response to the rollover predicting unit predicting the rollover of the vehicle.

### BRIEF DESCRIPTION OF DRAWINGS

Objects, features and advantages of the present disclosure will become apparent from the following detailed description made with reference to the accompanying drawings. In the drawings:

FIG. 1 is a diagram showing a mounting position of a vehicular emergency notification device;

FIG. 2 is a cross-section view of the vehicular emergency notification device;

FIG. 3 is a diagram showing a configuration of the vehicular emergency notification device;

FIG. 4 is a diagram showing a process executed by a wireless communication unit and a rollover predicting unit;

FIG. 5 is a diagram showing S2 in FIG. 4 for determination;

FIG. 6 is a diagram illustrating a determination for a higher possible rollover;

FIG. 7 is a diagram illustrating the posture of the vehicle when the higher possible rollover is determined; and

FIG. 8 is a diagram illustrating a roll angle threshold value for determining the higher possible rollover.

### DETAILED DESCRIPTION

There has been known an emergency notification device which detects a collision accident occurred in a vehicle and transmits an emergency notification signal to a center or the like outside the vehicle. Further, a device for determining whether or not a vehicle may roll over is known.

When a vehicle rolls over, it is necessary to make an emergency notification, as in the situation of collision. However, if the vehicle rolls over, a wireless communication unit of the emergency notification device may be damaged. As a result, it is possible that when the vehicle rolls over, such emergency is not notified.

The present disclosure provides a vehicular emergency notification device mounted on a vehicle. The vehicular emergency notification device includes: a wireless communication unit wirelessly transmitting an emergency notification signal toward outside of the vehicle; and a rollover predicting unit acquiring a rollover-related quantity, which is a physical quantity for predicting a rollover of the vehicle, and predicting the rollover of the vehicle based on the acquired rollover-related quantity. The wireless communication unit transmits the emergency notification signal in response to the rollover predicting unit predicting the rollover of the vehicle.

In a configuration where the emergency notification signal is transmitted after the rollover, the emergency notification signal may not be able to transmitted when the wireless communication unit stops working due to the rollover. However, the vehicular emergency notification device according to the present disclosure transmits the emergency notification signal at the stage of predicting the rollover before it happens. Therefore, since the emergency notification signal has already been transmitted, even if the wireless communication unit cannot be used after rollover of the vehicle, it is possible to suppress situations in which the emergency notification signal is not transmitted when the vehicle rolls over.

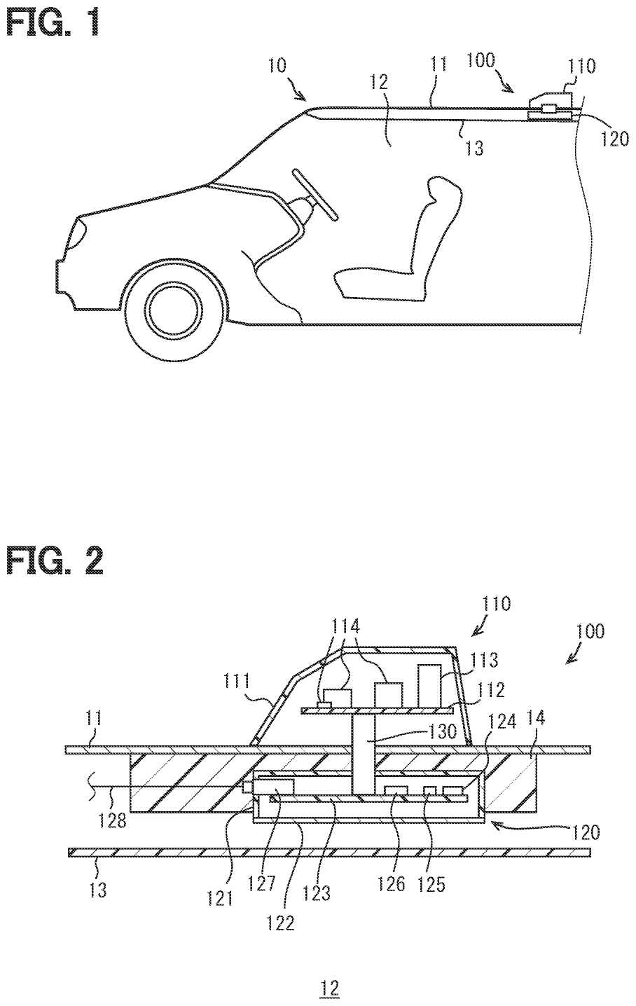

The following describes embodiments of the present disclosure with reference to the drawings. FIG. 1 is a diagram showing a mounting position of the vehicular emergency notification device 100 of the present embodiment. As shown in FIG. 1, the vehicular emergency notification device 100 is mounted under a roof plate 11 of the vehicle 10. The roof plate 11 is a metal plate constituting the roof of the vehicle 10. The vehicular emergency notification device 100 is installed at the rear end of the roof plate 11 in the front-rear direction of the vehicle, and at the center in the width direction of the vehicle.

As shown in FIG. 1, the vehicular emergency notification device 100 has an upper portion 110 positioned on the roof plate 11 and a lower portion 120 positioned between the roof plate 11 and a ceiling lining 13 of a vehicle interior 12. The ceiling lining 13 is a part of the ceiling of the vehicle interior 12, and is usually called a liner. The ceiling lining 13 is made of resin, such as polypropylene.

FIG. 2 shows a cross-section view of the vehicular emergency notification device 100. The cross-section view shown in FIG. 2 is a cross-section view vertical to the width direction of the vehicle. The upper portion 110 includes a housing 111. The housing 111 is made of resin and protrudes from the roof plate 11.

An antenna circuit board 112 is housed in the housing 111. The antenna circuit board 112 has an outer surface made of insulating base material and an inner surface on which a predetermined wiring pattern is arranged.

Further, an antenna 113 and circuit elements 114 are attached to the antenna circuit board 112. The antenna 113 communicates with a center outside the vehicle 10. The antenna 113 is positioned protuberant from the antenna circuit board 112. The antenna 113 is, for example, a monopole antenna. The circuit elements 114 amplify transmitted and received signals, remove noise, and the like.

The lower portion 120 includes a housing 121. The housing 121 is made of resin. The housing 121 is hollow parallelepiped rectangular, and one of the six surfaces is open. An aluminum cover 122 is positioned on the open surface of the housing 121 in order to close the opening of the housing 121. The housing 121 is positioned below the lower surface of the roof plate 11 via a heat insulating member 14.

A communication circuit board 123 is housed in the housing 121. Similar to the antenna circuit board 112, the communication circuit board 123 also has an outer surface made of insulating base material and an inner surface on which a predetermined wiring pattern is arranged.

The communication circuit board 123 and the antenna circuit board 112 are electrically connected by an inter-board connector 130. A gyro sensor 124, an acceleration sensor 125, a communication IC 126, and a connector 127 are attached to the communication circuit board 123. The gyro sensor 124 detects at least a rotational speed of the vehicle 10 about a front-rear axis, which is a roll angular velocity. In one embodiment, the gyro sensor 124 may be configured to detect one or both of a rotation speed about a left-right axis of the vehicle 10, which is a pitch angular velocity, and a rotation speed about a top-bottom axis of the vehicle 10, which is a yaw angular velocity.

The acceleration sensor 125 detects an anteroposterior acceleration of the vehicle 10. The acceleration sensor 125 detects one or both of a lateral acceleration of the vehicle 10 and a vertical acceleration of the vehicle 10. In the present embodiment, a possibility of rollover of the vehicle 10 is predicted based on the signal detected by the gyro sensor 124 and the signal detected by the acceleration sensor 125. Therefore, the gyro sensor 124 and the acceleration sensor 125 correspond to rollover-related quantity sensors, and the physical quantities detected by the rollover-related quantity sensors are

the rollover-related quantities. The communication IC 126 is configured to include at least one processor, and transmit/receive signals to/from various electronic devices in the vehicle 10 via a connector 127 and a signal line 128 connected to the connector 127.

Further, the communication IC 126 generates, modulates, and amplifies a signal to be transmitted from the antenna 113, and amplifies, demodulates, and decodes the signal received by the antenna 113. The signal generated by the communication IC 126 includes an emergency notification signal. The emergency notification signal is a signal that notifies a center outside the vehicle 10 or the like that an accident may occur in the vehicle 10.

The emergency notification signal is transmitted in response to a signal indicating deployment of an airbag of the vehicle 10 is input via the signal line 128 and the connector 127. When a rollover predicting unit 132 described below predicts rollover of the vehicle 10, the emergency notification signal is also transmitted.

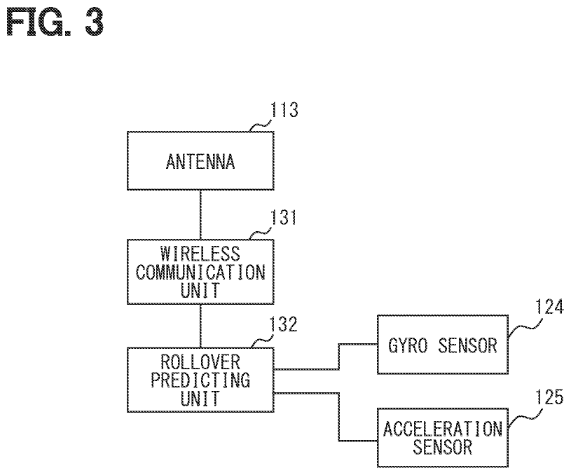

FIG. 3 is a block diagram showing a function of the vehicular emergency notification device 100. The vehicular emergency notification device 100 includes a wireless communication unit 131 and a rollover predicting unit 132. The wireless communication unit 131 has a calculation function implemented by the communication IC 126. The wireless communication unit 131 includes a circuit unit and the circuit elements 114 for performing amplification and the like. The circuit unit may be provided by the communication IC 126. The wireless communication unit 131 communicates with the center via, for example, a mobile communication network. The rollover predicting unit 132 is implemented by the calculation function of the communication IC 126.

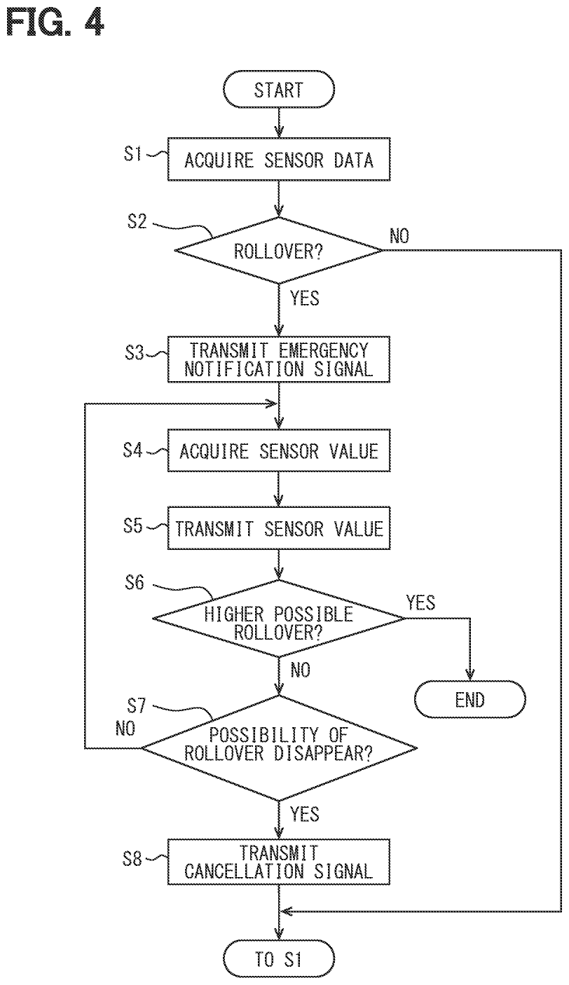

FIG. 4 is a diagram showing a process executed by the wireless communication unit 131 and the rollover predicting unit 132. In FIGS. 4, S3 and S8 are executed by the wireless communication unit 131, and the rest are executed by the rollover predicting unit 132. The wireless communication unit 131 and the rollover predicting unit 132 periodically execute the process shown in FIG. 4 during an electric power-on state of the vehicular emergency notification device 100. When an electric power supply of the vehicle 10 is on, a main battery mounted on the vehicle 10 supplies electric power to the vehicular emergency notification device 100. In one example, a backup battery may be provided, and electric power may be supplied from the backup battery when the electric power is not supplied from the main battery.

The process shown in FIG. 4 will be described. In S1, the sensor value is acquired. In the present embodiment, the sensor values include the roll angular velocity detected by the gyro sensor 124 and the anteroposterior acceleration detected by the acceleration sensor 125. In S2, the process determines whether a rollover of the vehicle 10 is predicted based on the sensor value acquired in S1.

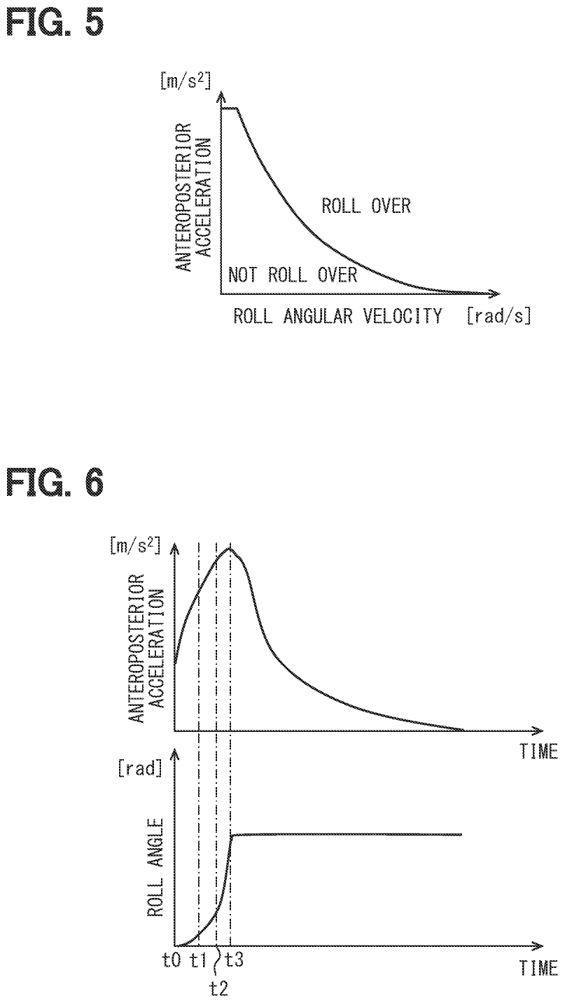

FIG. 5 is a diagram showing an example of determining step in S2. FIG. 5 shows a relationship that when the roll angular velocity increases and the anteroposterior acceleration decreases, the vehicle 10 is predicted to roll over. FIG. 5 also shows a relationship that when the anteroposterior acceleration is high, even if the roll angular velocity is low, the vehicle 10 is predicted to roll over. In S2, whether or not the vehicle 10 rolls over is predicted based on the relationship shown in FIG. 5 and the sensor value acquired in S1.

When the result determined in S2 is “NO”, once the process shown in FIG. 4 is completed, and S1 will be executed after the execution cycle has elapsed. On the other hand, when the result determined in S2 is “YES”, the process proceeds to S3. In S3, an emergency notification signal is transmitted to a predetermined center. The emergency notification signal includes a signal indicating that an accident may have occurred in the vehicle 10. In addition, the signal indicating the sensor value acquired in S1 is also included in the emergency notification signal. After executing S3, the process proceeds to S4.

In S4, similar to S1, the roll angular velocity detected by the gyro sensor 124 and the anteroposterior acceleration detected by the acceleration sensor 125 are acquired. In S5, a signal indicating the sensor value acquired in S4 is transmitted to the center.

In S6, the process determines whether or not the vehicle 10 rolls over at a high possibility based on the sensor value acquired in S4. FIG. 6 illustrates determination for a higher possible rollover. The upper part of FIG. 6 shows a change of the anteroposterior acceleration of the vehicle over time. The lower part of FIG. 6 shows a change of the roll angle over time. The roll angle can be calculated by integrating the roll angular velocities acquired sequentially.

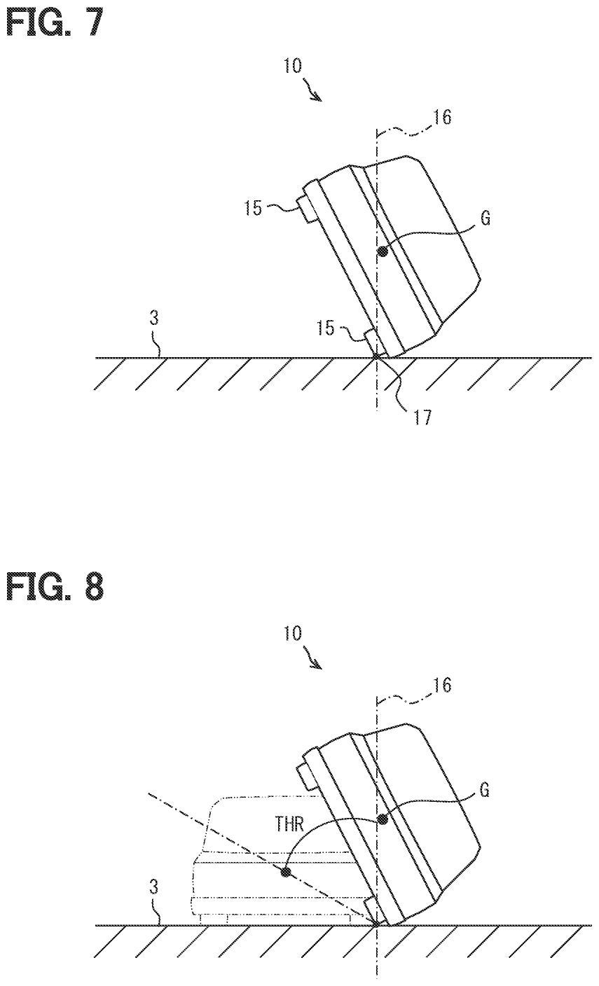

At a time point t0, the roll angular velocity is 0 and the vehicle 10 starts rotating in a roll angular direction. At a time point t1, the vehicle 10 is predicted to roll over in S2. A point on the curve corresponding to a time point t2 is an inflection point that indicates a change in roll angle. After the time point t2, the roll angular velocity increases. As shown in FIG. 7, at the time point t2, the center of gravity G of the vehicle 10 crosses a rollover determination plane 16.

The rollover determination plane 16 is a vertical plane including a ground contact point 17 at which the front and rear wheels 15 on one side contact with a road surface 3 when the wheels 15 on the other side separate from the road surface 3. When the center of gravity G of the vehicle 10 crosses the rollover determination plane 16, the roll angular velocity of the vehicle 10 increases due to the weight of the vehicle 10. At the time point t2, the process determines the higher possible rollover of the vehicle 10.

At the time point t1, the vehicle 10 is predicted to roll over. Therefore, in the present embodiment, rolling over of the vehicle 10 is predicted before the center of gravity G of the vehicle 10 exceeding the rollover determination plane 16 toward the wheels 15 on the opposite side of the wheels separating from the road surface 3.

At a time point t3, the vehicle 10 rolls over. Rolling over of the vehicle 10 is a state in which the side surface or the upper surface of the vehicle 10 is in contact with an obstacle and the vehicle 10 is not moving. As the vehicle 10 rolls over, the roll angle hardly changes with time. When the vehicle rolls over, the vehicle 10 cannot move, such that the anteroposterior acceleration suddenly decelerates after the time point t3.

In FIG. 8, a state in which all of the wheels 15 of the vehicle 10 are in contact with the road surface 3 is shown by a double dash. A roll angle threshold value THR in FIG. 8 is an amount of change in the roll angle of the vehicle 10 from when all the wheels 15 of the vehicle 10 are in contact with the road surface 3 until the center of gravity G exceeds the rollover determination plane 16. This roll angle threshold THR can be calculated in advance. In S6, the change in roll angle can be calculated by integrating the roll angular velocity. When the change in roll angle exceeds the roll angle threshold value THR, the higher possible rollover of the vehicle 10 is determined. The calculation of the change in roll angle starts when the vehicle 10 starts rotating in the roll angle direction. Whether the vehicle 10 starts to rotate in the roll angular direction can be determined from the roll angular velocity.

At the time the higher possible rollover of the vehicle 10 is determined, the vehicle 10 has not rolled over yet. Therefore, it is highly likely that the vehicular emergency notification device 100 has not been damaged, and the vehicular emergency notification device 100 can execute the process of S7 and the following steps. When the determination in S6 is “YES”, the process shown in FIG. 4 is terminated. Since the emergency notification signal has already been transmitted, no additional processing is required at that time. When the determination result of S6 is “YES”, unlike the situation when the determination result of S2 is “NO”, the process shown in FIG. 4 cannot be re-executed.

When the determination result of S6 is “YES”, the process may not be terminated immediately. The sensor value may be continuously received and a signal indicating the received sensor value may be transmitted. However, in a case where the vehicle 10 actually rolls over, it is possible that the signal indicating the sensor value cannot be transmitted due to damage to the vehicular emergency notification device 100 or the like.

When the determination result of S6 is “NO”, the process proceeds to S7. In S7, it is determined whether or not the possibility of rollover has disappeared. For example, in a case where the roll angle starts to decrease, it can be determined that the possibility of rollover has disappeared. In order to have more reliable determination, the device may be configured to determine that the possibility of rollover has disappeared when the roll angle has returned to the angle at the time point to.

When the determination result of S7 is “NO”, the higher possible rollover of the vehicle is not determined, and it cannot be considered as the vehicle 10 is no longer likely to roll over. When the determination result of S7 is “NO”, the process returns to S4 and acquires the latest sensor value.

On the other hand, in a case where the result determined in S7 is “YES”, the process proceeds to S8. In S8, a cancellation signal is transmitted in order to cancel the emergency notification signal transmitted in S3. When S8 is executed, as the situation when the determination result of S2 is “NO”, the process shown in FIG. 4 completes, and then S1 is executed after the execution cycle has finished.

### Brief of Embodiment

In a case where the vehicle 10 is configured to start transmitting the emergency notification signal after the vehicle rolls over, the emergency call signal cannot be transmitted since the wireless communication unit 131 may become unusable due to the rollover. However, the vehicular emergency notification device 100 according to the present disclosure transmits the emergency notification signal at the stage of predicting the rollover before the vehicle 10 rolls over (S2, S3). Therefore, even if the wireless communication unit cannot be used after the vehicle has rolled over, since the emergency notification signal has already been transmitted, it is possible to suppress the situation in which the emergency notification signal is not transmitted when the vehicle rolls over. In one embodiment, it is desirable to have the emergency notification signal transmitted as soon as possible. Since the vehicular emergency notification device 100 transmits the emergency notification signal before the vehicle 10 rolls over, it is advantageous that the emergency notification signal can be transmitted at an earlier time than the deployment of the airbag.

The vehicular emergency notification device 100 includes the gyro sensor 124 and the acceleration sensor 125, which are sensors for detecting the rollover-related quantities for predicting rollover of the vehicle 10. The gyro sensor 124 and the acceleration sensor 125 are housed in the same housing 121 as the wireless communication unit 131. Therefore, a prediction failure of rollover of the vehicle 10 can be avoided when the gyro sensor 124 and the acceleration sensor 125 fail to detect the rollover-related quantities but the wireless communication unit 131 operates normally.

Further, since the vehicular emergency notification device 100 transmits the emergency notification signal at the stage of predicting the rollover before the actual rollover of vehicle 10, there is a possibility that the vehicle 10 did not actually roll over. Therefore, in the present embodiment, after predicting the rollover of vehicle 10 (S2: YES), once the possibility of rollover of the vehicle 10 is eliminated (S7: YES), a cancellation signal is transmitted (S8). In this regard, the risk caused by transmitting the emergency notification signal at the stage where the rollover is predicted can be lowered.

In the present embodiment, the emergency notification signal transmitted to the center includes the signal indicating the sensor value used for predicting rollover of the vehicle 10. Even after transmitting the emergency notification signal, the sensor values are sequentially acquired and the signals indicating the acquired sensor values are transmitted to the center (S4, S5). As a result, even at the center, it is possible to determine whether or not the vehicle 10 will roll over based on the transmitted sensor value.

Although the embodiments have been described above, the disclosed technology is not limited to the above-described embodiments, and the following modifications are included in the present disclosure, and various modifications can be made without departing from the spirit of the present disclosure. In the following description, elements having the same reference numbers as the elements described above refer to the same elements, except the specifically mentioned ones. When only a part of the configuration is described, the embodiments described above can be applied to the other parts of the configuration.

### Modification 1

In the above embodiment, the rollover of the vehicle 10 is preliminarily determined before determination of higher possible rollover. However, even at the time when the higher possible rollover of the vehicle 10 is determined, for example, the time point t2 in FIG. 6, the vehicle 10 has not actually rolled over yet. The rollover prediction of the vehicle 10 may be made after the time point t2 or the like when the higher possible rollover of the vehicle 10 is determined and before the vehicle 10 actually rolls over.

### Modification 2

In the above embodiment, the roll angular velocity and the vehicle anteroposterior acceleration are used as the rollover-related quantities. However, there are various rollover-related quantities other than the combination of these two. For example, only the roll angular velocity may be used as the rollover-related quantity. In the situation that only the roll angular velocity is used as the rollover-related quantity, it can directly predict rollover of the vehicle 10 based on the roll angular velocity only. In addition, the change of roll angle can be calculated based on the roll angular velocity and rollover of the vehicle 10 can be predicted by using the roll angular velocity and the change of roll angle. For example, when the condition “roll angle threshold THR−change of roll angle<roll angular velocity×α (α is a coefficient)” is met, it may predict that the vehicle 10 will roll over. When the above inequality is established, the center of gravity G of the vehicle 10 has not yet exceeded the rollover determination plane 16. However, since the vehicle 10 is rotating in the direction of rolling over, it can be predicted that the vehicle 10 will roll over.

Further, the roll angular velocity can be decomposed into a lateral angular velocity and a vertical acceleration of the vehicle 10. Therefore, instead of the gyro sensor 124, an acceleration sensor that detects the lateral angular velocity and the vertical acceleration of the vehicle 10 may be used as the rollover-related quantity sensor. Of course, the lateral angular velocity and vertical acceleration of the vehicle 10 may be used in addition to the anteroposterior acceleration of the vehicle 10 to predict the rollover of the vehicle 10, as in the above embodiment.

Further, when determining whether or not the vehicle 10 rolls over based on the rollover-related quantities, the roll angle threshold THR may be corrected based on the roll angle when all wheels 15 are in contact with the road surface 3. Whether all wheels 15 are in contact with the road surface 3 can be determined, for example, by the fact that there is almost no change in the roll angular velocity.

### Modification 3

In the above embodiment, the gyro sensor 124 and the acceleration sensor 125, which are rollover-related quantity sensors, are housed in the housing 121 of the lower portion 120. Alternatively, at least one of the gyro sensor 124 or the accelerometer 125 may be housed in the housing 111 of the upper 110.

### Modification 4

The vehicle 10 may include a rollover-related quantity sensor such as a gyro sensor and an acceleration sensor separate from the vehicular emergency notification device 100. In this case, the vehicular emergency notification device 100 does not have a rollover-related quantity sensor, and the rollover predicting unit 132 acquires the detection value from the rollover-related quantity sensor in the vehicle 10 and predicts whether the vehicle 10 will roll over.

### Modification 5

The antenna 113 may be a planar antenna provided in a flat plate-shaped conductor plate along with the antenna circuit board 112. When the antenna 113 is the planar antenna, the roof plate 11 may be recessed and the housing 111 may be accommodated in the recess.

### Modification 6

In the above embodiment, the wireless communication unit 131 sequentially transmits the acquired sensor values (S3, S5). Instead of or in addition to this, the wireless communication unit 131 may store the acquired sensor value in a predetermined storage unit in order to analyze the situation after the situation happens.

### Modification 7

After transmitting the emergency notification signal, a display or a speaker provided in the vehicle 10 may be used to notify an occupant of the vehicle 10 that an emergency notification signal has been transmitted. In one embodiment, a cancellation button that can be operated by the occupant may be provided in the vehicle such that the cancellation signal can be sent by the occupant manually.

### Modification 8

In the present disclosure, the wireless communication unit 131 and the rollover predicting unit 132 are provided by controllers. These controllers and methods thereof may be realized by a dedicated computer constituting a processor programmed to perform one or more functions embodied in a computer program. Alternatively, the control units and methods thereof described in the present disclosure may be realized by a dedicated hardware logic circuit. Alternatively, the control units and the methods thereof described in the present disclosure may be implemented by one or more dedicated computers configured to include a combination of a processor for executing computer programs and at least one hardware logic circuit. The hardware logic circuits may be, for example, ASIC or FPGA.

Further, a storage medium for storing the computer program is not limited to the ROM, and it may also be stored in a computer-readable non-transitory tangible recording medium as an instruction executed by the computer. For example, the above program may be stored in a flash memory.

What is claimed is:

1. A vehicular emergency notification device mounted on a vehicle, the vehicular emergency notification device comprising:
a wireless communication unit wirelessly transmitting an emergency notification signal toward outside of the vehicle; and
a rollover predicting unit acquiring a rollover-related quantity, which is a physical quantity for predicting a rollover of the vehicle, and predicting the rollover of the vehicle based on the acquired rollover-related quantity,
wherein the wireless communication unit transmits the emergency notification signal in response to the rollover predicting unit predicting the rollover of the vehicle.

2. The vehicular emergency notification device according to claim 1, wherein
the rollover predicting unit predicts the rollover of the vehicle after a wheel on a left or a right side of the vehicle separating from a road surface and before a center of gravity of the vehicle crossing a vertical plane including a point on the road surface at which another wheel of the vehicle contacts.

3. The vehicular emergency notification device according to claim 1, wherein:
the rollover predicting unit determines whether a possibility of rollover disappears after predicting the rollover of the vehicle; and
after transmitting the emergency notification signal, the wireless communication unit transmits a cancellation signal in order to cancel the emergency notification signal in response to the rollover predicting unit determining that the possibility of rollover disappears.

4. The vehicular emergency notification device according to claim 1, wherein
the wireless communication unit includes, in the emergency notification signal, a signal indicating the rollover-related quantity based on which the rollover of the vehicle is predicted.

5. The vehicular emergency notification device according to claim 4, wherein
the wireless communication unit transmits the signal indicating the rollover-related quantity even after the emergency notification signal is transmitted.

6. The vehicular emergency notification device according to claim 1, further comprising
a rollover-related quantity sensor detecting the rollover-related quantity,
wherein the rollover-related quantity sensor is located in a same housing as the wireless communication unit.

7. The vehicular emergency notification device according to claim 6, wherein
the rollover-related quantity sensor includes a gyro sensor that detects a roll angular velocity of the vehicle.

8. The vehicular emergency notification device according to claim 7, wherein
the rollover-related quantity sensor includes the gyro sensor and an acceleration sensor that detects an acceleration of the vehicle in a front-rear direction of the vehicle.

9. A vehicular emergency notification device mounted on a vehicle, the vehicular emergency notification device comprising:
a storage medium storing a computer program;
at least one processor, by executing the program, configured to:
transmit an emergency notification signal toward outside of the vehicle;
acquire a rollover-related quantity, which is a physical quantity for predicting a rollover of the vehicle, and predict the rollover of the vehicle based on the acquired rollover-related quantity; and
transmit the emergency notification signal in response to the predicted rollover of the vehicle.
